(19) United States
(12) Patent Application Publication
(10) Pub. No.: US 2023/0347831 A1
(43) Pub. Date: Nov. 2, 2023

(54) ACCESSORY BAR AND LOAD CARRYING ASSEMBLY

(71) Applicant: PLANT IP PTY LTD, Portsmith, Cairns, Qeensland (AU)

(72) Inventors: Gary Raymond PLANT, Portsmith, Cairns (AU); Ronald RAE, Portsmith, Cairns (AU)

(21) Appl. No.: 17/914,318

(22) PCT Filed: Mar. 24, 2021
(86) PCT No.: PCT/AU2021/050265

§ 371 Date: Sep. 23, 2022

(30) Foreign Application Priority Data
Mar. 24, 2020 (AU) 2020900895
Oct. 8, 2020 (AU) 2020903652

(51) Int. Cl. B60R 9/045; B60R 9/06

(52) U.S. Cl. CPC B60R 9/045; B60R 9/06

(57) ABSTRACT

An accessory bar (14) for a range of variously sized utility vehicles includes two spaced upright or inclined supporting portions (24) configured for assembly with a straight transverse portion (18) extendable at least between the two spaced supporting portions (24) to define an inverted U shape in assembled configuration. The accessory bar includes telescopically slidable portions (24, 74) for telescopic adjustment thereof to effect height adjustment of the transverse portion (18) in situ. An annular sheath (82) of plastic material is provided to insert between the telescopically slidable portions (24, 74).

### FIELD OF THE INVENTION

The present invention relates to an adjustable accessory bar to suit a range of different sized utility vehicles. Such vehicles are otherwise known as pick-up trucks or recreational vehicles. While the invention is described specifically in relation to utility vehicles, the invention may also have application to other kinds of vehicles such as trucks, trailers or any kind of apparatus or device used to support or carry a load.

### BACKGROUND OF THE INVENTION

Accessory bars for utility vehicles generally take the form of an inverted U shape, with inclined arms supporting a transverse bar. The accessory bar is arranged to extend across the cargo area (otherwise known as the “tub”), resting on the sides of the tub. Typically, two such accessory bars are spaced along the length of the vehicle so that loads can be placed spanning between the two accessory bars. Short loads span the two accessory bars over the top of the tub between whereas long loads may extend further, over the top of the cabin.

The dimensions of the cargo area for utility vehicles vary from vehicle to vehicle. Furthermore, the height from the top of the tub to the roof line of the cab also varies. Therefore, accessory bars for utility vehicles are generally custom-built for a particular type of utility vehicle. Currently in Australia there are about 40 different types of utility vehicles. Custom-made accessories have the disadvantage that they are not transportable from vehicle to vehicle. Therefore, a seller of a utility vehicle would not be able to use their accessory bar for their next vehicle.

Known accessory bars are typically welded constructions which have a number of disadvantages which include: a labour-intensive welding step; the creation of a weld zone more likely to fail due to changes in material properties of the surrounding metal; the unappealing aesthetics of a welded join; and the need for additional finishing steps on a welded join.

The aim of the present invention is to overcome or at least address some of the above-mentioned disadvantages. An alternative object of the present invention is to provide the public with a useful choice over known accessory bars and load carrying assemblies.

Reference to any prior art in the specification is not an acknowledgment or suggestion that this prior art forms part of the common general knowledge in any jurisdiction or that this prior art could reasonably be expected to be understood, regarded as relevant, and/or combined with other pieces of prior art by a skilled person in the art.

### SUMMARY OF THE INVENTION

### Plastic Sheath

In accordance with a first aspect of the present invention, there is provided, an accessory bar for a range of variously sized utility vehicles, the accessory bar including two spaced upright or inclined supporting portions configured for assembly with a straight transverse portion extendable at least between the two spaced supporting portions to define an inverted U shape in assembled configuration, wherein the accessory bar includes telescopically slidable portions for telescopic adjustment thereof to effect height adjustment of the transverse portion in situ, wherein a first annular sheath of plastic material is provided to insert between the telescopically slidable portions.

Preferably the first sheath of plastic material is a longitudinally split annulus having a plurality of portions. The first sheath or portions thereof include a first transversely extending first lip to retain the first sheath or portions thereof in position during telescopic adjustment.

The accessory bar may also include: laterally telescopic portions for adjustment of the lateral spacing between the two supporting portions to adapt the accessory bar for a range of various sized utility vehicles; and a second annular sheath of plastic material is provided to insert between the laterally telescopic portions. The second annular sheath of plastic material may be a longitudinally split annulus having a plurality of portions. The second sheath or portions thereof include a transversely extending second lip to retain the second sheath or portions thereof in position during telescopic adjustment.

Furthermore an end cap may be provided for one of the laterally telescopic portions with the other of the laterally telescopic portions configured to pass through the end cap, with the second lip configured to bear against the end cap.

No-Weld and Oval Cross-Section Elbows

In accordance with another aspect of the present invention, there is provided an accessory bar for a range of various sized utility vehicles, the accessory bar including two spaced elbow portions configured for assembly with a spanning portion extendable at least between the two spaced elbows to define an inverted U shape in assembled configuration, with the elbows defining a respective corner of the inverted U shape, such that the spanning portion is adjustable in relative position with at least a first of the two spaced elbow portions to provide adjustment in spacing between the two elbow portions, wherein at least said first elbow portion is a hollow tubular section of oval cross-section formed without welding.

In accordance with another aspect of the present invention, there is provided an accessory bar for a range of various sized utility vehicles, the accessory bar including two spaced elbow portions configured for assembly with a spanning portion extendable at least between the two spaced elbows to define an inverted U shape in assembled configuration, with the elbows defining a respective corner of the inverted U shape, such that the spanning portion is adjustable in relative position with at least a first of the two spaced elbow portions to provide adjustment in spacing between the two elbow portions, wherein at least said first elbow portion is a hollow tubular section of oval cross-section being essentially/substantially/generally a single piece construction.

The requirement for a single piece construction does not preclude the existence of additional pieces forming parts of vehicle mounts to attach each elbow portion to the vehicle.

Having elbow portion(s) formed without welding may provide an essentially single piece construction for the elbow portion(s). In other words, if the elbow portion is defined by an upright or inclined supporting portion and a crosswise portion, in the no-weld design, the supporting portion and the crosswise portion are unified without welding. In most preferred form, the elbow portion(s) may be formed unitarily, i.e. without the joining of separate parts. For example, the elbow portion(s) may be formed from hollow tubular section which is bent into the desired elbow shape. Preferably, the hollow tubular section is an extruded oval section. The oval cross-section may be formed from a round cross-section by pressing a cut length of round tubing to acquire an oval cross-section. The elbow bend may be formed in a subsequent or the same pressing operation.

In an alternative form of the invention, the elbow portion(s) may be cast. While it is intended that the elbow portion(s) will be formed from metal for strength reasons, extruded and moulded plastics are also within the scope of the invention. The elbow portion(s) may be hollow or solid.

The above design therefore avoids the disadvantages associated with welded constructions.

It is possible that the spanning portion is unified with a second of the elbow portions. In such an embodiment, the adjustment is between the unified spanning portion and the first elbow portion on the one hand, and a second elbow portion on the other hand.

However, preferably, the spanning portion and the two elbow portions comprise three discrete members. In such an embodiment, the adjustment is between the spanning portion and at least the first elbow portion. In most preferred form of the invention, the adjustment is between the spanning portion and both elbow portions.

The adjustment is preferably a sliding adjustment. In a most preferred form of the invention, the spanning portion is telescopically adjustable relative to the elbow portion(s). Preferably, the first elbow portion is received within the spanning portion for telescopic sliding adjustment.

To facilitate telescopic adjustment, a plastic sleeve may be provided between the spanning portion and the associated adjustable elbow portion. Such a plastic sleeve may be a heat shrinkable plastic sleeve.

The adjustment may allow for a discrete number of relative positions between the spanning portion and the elbow portion(s).

The accessory bar may be symmetrical about a centre point of the spanning portion. Furthermore, the elbow portions are preferably symmetrical about a centre point of the spanning portion. In a most preferred form of the invention, both elbow portions may be the same.

Preferably, height adjustment of the accessory bar is provided by an adjustment mechanism at the end of the elbow portions remote from the spanning portion. The adjustment mechanism may include vehicle mounts, to secure the accessory bar to the vehicle. Preferably, each of the elbow portions is adjustable relative to its associated vehicle mount to provide for height adjustment of the accessory bar.

Typically, in use, two such accessory bars are spaced in the lengthwise direction of the vehicle, allowing items to be carried e.g. sporting equipment such as skis, to extend between the two spaced accessory bars.

Further, a vehicle mount may be provided to clamp at least a portion of one or more accessory bars to one side of the vehicle. A second vehicle mount may be provided to clamp at least another portion of the one or more accessory bars to the other side of the vehicle.

The vehicle mount may include any of the features described in connection with other aspects of the invention.

### Adjustable Accessory Bar and Removably Attached Crossbar

In accordance with a yet another aspect of the present invention, there is provided a load carrying assembly for a range of variously sized utility vehicles, the assembly including: an accessory bar including two supporting portions and a straight transverse portion extendable therebetween to define an inverted U shape in assembled configuration wherein the distance between the two supporting portions is adjustable to adapt the accessory bar for a range of various sized utility vehicles; and a crossbar, wherein the crossbar is removably connectable to the accessory bar, the crossbar exceeding the transverse portion in length.

Typically, in use, two such load carrying assemblies may be spaced lengthwise of the vehicle to carry items such as sporting goods e.g. skis extending lengthwise along the vehicle and thus spanning between the two bar assemblies. Depending upon the items to be carried, the accessory bars may be of overall sufficient width. The removable crossbar (attached to a respective accessory bar) increases the functionality by allowing wider items to be carried by the vehicle because the crossbar exceeds the straight transverse portion in length.

Further, a clamp bar may be provided to clamp at least a portion of one or more load carrying assemblies to one side the vehicle. A second clamp bar may be provided to clamp at least another portion of the one or more load carrying assemblies to the second side of the vehicle.

The accessory bar may be in the form set out in the first aspect of the invention.

Preferably, the crossbar is removably connectable to the straight transverse portion. The transverse portion may include engagement features for removable connection of the crossbar. The transverse portion and the crossbar may include mutually engageable portions. For example, the transverse portion and the crossbar may have adjacent flat surfaces and/or complementary shapes where the transverse portion and the crossbar abut. In other words, the transverse portion and the crossbar may be in direct contact with each other. Thus, the transverse portion may support the crossbar along its whole length. This may enable the crossbar to be of lower structural strength since the transverse portion is load supporting.

Further, the transverse portion and the crossbar may each have recesses to house the fastening means to interconnect the transverse portion in the crossbar. For example, the transverse portion and the crossbar may each be in the form of an extruded hollow section with an elongate recess formed as part of the extruded hollow section to house the fastening means. In one form, there is a common means to secure relatively movable parts of the adjustable accessory bar and to secure the crossbar to the accessory bar. For example, a set of fasteners may engage with a lock member to secure the transverse portion relative to the elbow portions and another set of fasteners may engage with the same lock member to secure the crossbar to the transverse portion. The lock member may be in the form of an elongate member providing multiple threaded holes for the fasteners.

The transverse portion may also facilitate connection of other accessories such as a light bar.

The crossbar may include bookends to retain items placed upon the crossbar. The bookends may be in the form of upright supports, extending upwardly from the crossbar.

Any of the features described in connection with the other aspects of the invention may apply to this aspect of the invention.

### Clamping Vehicle Mount

In accordance with a further aspect of the present invention, there is provided, a vehicle mount to mount at least a portion of an accessory bar to a vehicle wherein the vehicle mount includes an elongate clamp bar which is removably attachable to the vehicle by clamping to the vehicle by means of a clamp mechanism, the elongate clamp bar forming part of the clamp mechanism and wherein the clamp bar has a profile shaped for engagement along its length with the side wall of the vehicle.

Accordingly, the vehicle mount facilitates connection of said at least a portion of the accessory bar to the vehicle without the need to drill holes in the tub of the vehicle. Preferably, at least two vehicle mounts are provided to mount opposite ends of the accessory bar to the vehicle. In a preferred arrangement, two vehicle mounts may be provided to mount two accessory bars, each vehicle mount being provided on a respective side of the vehicle.

In a preferred form, the elongate clamp bar includes:

a first portion having a substantially flat engagement surface for support by a top of the side wall of the utility vehicle; and

a second portion having a substantially flat engagement surface for support against an inner side of the side wall of the utility vehicle

Preferably, a clamping portion is provided to clamp the clamp bar to the vehicle. The clamping portion may include an underhang portion which lies beneath the first portion from which a plurality of fasteners extend to clamp against an underside of the top of the side wall of the vehicle.

While the first and second portions may bear against respective surfaces of the utility vehicle side wall, intervening gaskets or pads may be provided to protect the vehicle against scratching.

The clamp bar is elongate and accordingly may support the mounting of at least a portion of two adjacent accessory bars on the same vehicle.

Furthermore, the vehicle mount may include one or more mounting brackets to attach said at least a portion of the accessory bar to the clamp bar. The mounting bracket may include:
a first portion for support by the first portion of the clamp bar, the first portion having a lengthwise direction;
a second portion for support by the second portion of the clamp bar, the second portion having a lengthwise direction; and
a third portion for connection to the accessory bar, the third portion having a lengthwise direction,

wherein the lengthwise direction of the third portion extends transversely to the lengthwise direction of each of the first and second portions.

The first and second portions may be connectable respectively to the first and second portion of the elongate clamp bar by way of mountings incorporated into the elongate clamp bar.

The mounting bracket may be used to support the accessory bar as set out in connection with any other aspects of the invention. This configuration provides for balanced load-bearing. To support a single accessory bar, two mounting brackets are provided, one at the lower end of each supporting portion.

The third portion is intended to align with the longitudinal axis of the supporting portion of the accessory bar. Thus, in preferred embodiments, the third portion is inclined to the vertical, typically at 15° to the vertical. On the other hand, the first portion is substantially horizontal and the second portion is substantially vertical. By locating the mounting bracket relative to the vehicle using the first and second portions, the desired angle of the third portion is ensured. Such a configuration allows for more balanced load-bearing.

In the preferred form, the second portion of both the clamp bar and the mounting bracket lies inboard of the side of the vehicle, against the inside of the cargo area (tub).

Any of the first portion, the second portion and the third portion may comprise metal plates. The first portion, second portion and third portion may be integral. For example, the first, second and third portions may be welded together. However, in a more preferred form of the invention the first, second and third portions are formed unitarily, i.e. without the joining of separate parts, for example by forging, being cast or bent from a single piece of sheet metal.

Each mounting bracket may form part of a vehicle mount to support the end of the supporting portion. The vehicle mount may provide an adjustable connection with the supporting portion for height adjustment of the accessory bar. The vehicle mount may provide a sliding telescopic adjustment with the supporting portion.

In a preferred form, an inner bar is fixedly mounted on the third portion to facilitate sliding telescopic adjustment with the supporting portion. For example, the inner bar may be a hollow extruded section which receives the third portion, with the inner bar being received within the supporting portion. The inner bar may be regarded as part of the accessory bar or the vehicle mount. Irrespectively, telescopic sliding adjustment is provided between parts for height adjustment.

Since the supporting portion slides relative to the inner bar, depending upon the adjusted position, a section of the inner bar may be revealed. This reveal may be covered by a cover. As the product may be sold in kit form, the kit may provide a range of different length covers, so that a cover of suitable length may be selected to suit the selected height of the accessory bar. Also included is a plastic boot to receive the lower end of the inner bar to protect the vehicle from scratching. A collar may also be provided to cover the joints between the selected cover and the supporting portion.

In an alternative form, the vehicle mount (or the accessory bar) may further include an outer shroud which surrounds the supporting portion in the assembled configuration. The outer shroud covers the reveal, depending on the adjusted position, and strengthens the vehicle mount.

The outer shroud may include a rib. Furthermore, the mounting bracket may include fourth portion in the form of a gusset. The gusset is attachable to the rib on the outer shroud. The gusset further strengthens the vehicle mount. The gusset may be formed unitarily with the mounting bracket.

Any of the features described in connection with the other aspects of the invention may apply to this aspect of the invention.

Another aspect of the invention may reside in an accessory bar assembly/load carrying assembly including the accessory bar as set out in connection with other aspects and the vehicle mount set out above.

Any of the features described in connection with the other aspects of the invention may apply to this aspect of the invention.

### Accessory Bar with Oval Cross-Section

In accordance with still another aspect of the present invention, there is provided an accessory bar for a utility vehicle, the accessory bar including two supporting portions and a straight transverse portion extendable at least between the two supporting portions to define an inverted U shape in assembled configuration wherein the distance between the two supporting portions is adjustable to adapt the accessory bar for a range of various sized utility vehicles, wherein the accessory bar has an oval cross-section.

The oval cross section is stronger against side loads than prior art circular cross-sectional accessory bars.

The accessory bar may include an elbow portion having an oval cross-section. The oval cross-section may be formed from a round cross-section by pressing a cut length of round tubing to acquire an oval cross-section. The elbow bend may be formed in a subsequent or the same pressing operation.

Any of the features described in connection with the other aspects of the invention may apply to this aspect of the invention.

It will be understood that the invention disclosed and defined in this specification extends to all alternative combinations of two or more of the individual features mentioned or evident from the text or drawings. All of these different combinations constitute various alternative aspects of the invention.

As used herein, except where the context requires otherwise, the term “comprise” and variations of the term, such as “comprising”, “comprises” and “comprised”, are not intended to exclude further additives, components, integers or steps.

Further aspects of the present invention and further embodiments of the aspects described in the preceding paragraphs will become apparent from the following description, given by way of example and with reference to the accompanying drawings.

### BRIEF DESCRIPTION OF THE DRAWINGS

In order that the invention may be more fully understood, one embodiment will now be described by way of example with reference to the figures in which:

FIG. 1 is a perspective view of two installed load carrying assemblies in accordance with a first preferred embodiment of the present invention;

FIG. 2 is a longitudinal sectional view of an accessory bar which forms part of one of the load carrying assemblies shown in FIG. 1;

FIG. 3 is an exploded view of the accessory bar shown in FIG. 2;

FIG. 4 is a part perspective, sectioned view through the accessory bar shown in FIG. 2;

FIG. 5 is a cross-sectional view through the accessory bar shown in FIG. 2;

FIG. 6 is a partial longitudinal sectional view through the accessory bar shown in FIG. 2 in a first retracted position;

FIG. 7 is a partial longitudinal sectional view corresponding to FIG. 6, except with the accessory bar shown in a second extended position;

FIGS. 8A-8D are perspective views of mounting brackets, each shown in the orientation corresponding to the assembled configuration of the load carrying assembly shown in FIG. 1;

FIG. 9 is an underside view illustrating the mounting bracket engaging with a lower portion of the accessory bar shown in FIG. 2;

FIG. 10A is a partial longitudinal sectional view of a lower portion of the accessory bar shown in FIG. 2 in a retracted configuration;

FIG. 10B is a partial longitudinal sectional view corresponding to FIG. 10A, except showing the lower portion in an extended configuration;

FIG. 11 is a longitudinal sectional view of a load carrying assembly including both an accessory bar and a crossbar;

FIG. 12 is a longitudinal sectional view of the load carrying assembly additionally including a light bar;

FIG. 13 is an exploded view of the crossbar illustrated in FIG. 11;

FIG. 14 is a cross-sectional view through the load carrying assembly illustrated in FIG. 11;

FIG. 15 is a partial longitudinal sectional view through the load carrying assembly illustrated in FIG. 11;

FIG. 16 is a perspective view of two installed load carrying assemblies in accordance with a second preferred embodiment of the present invention;

FIG. 17 is a longitudinal sectional view of an accessory bar which forms part of one of the load carrying assemblies shown in FIG. 16;

FIG. 18 is an exploded view of the accessory bar shown in FIG. 17;

FIG. 19 is a part perspective, sectioned view through the accessory bar shown in FIG. 17;

FIG. 20 is a cross-sectional view through the accessory bar shown in FIG. 17;

FIG. 21A is a partial longitudinal sectional view through the accessory bar shown in FIG. 17 in a first retracted position;

FIG. 21B is a partial longitudinal sectional view corresponding to FIG. 21, except with the accessory bar shown in a second extended position;

FIG. 21C is a perspective view of the inner end of the elbow assembled with the liner but removed from the spanning member 18;

FIG. 22 is an underside view of the accessory bar shown in FIG. 17;

FIGS. 23A-23D are perspective views of mounting brackets, each shown in the orientation corresponding to the assembled configuration of the load carrying assembly shown in FIG. 16;

FIG. 24 is an underside view illustrating the mounting bracket engaging with a lower portion of the accessory bar shown in FIG. 17;

FIG. 25A is a partial longitudinal sectional view of a lower portion of the accessory bar shown in FIG. 17 in a retracted configuration;

FIG. 25B is a partial longitudinal sectional view corresponding to FIG. 25A, except showing the lower portion in an extended configuration;

FIG. 25C is a cross-sectional rendering through the lower end of the accessory bar illustrating the internal detail;

FIG. 26 is a longitudinal sectional view of a load carrying assembly including both an accessory bar and a crossbar;

FIG. 27 is an exploded view of the crossbar illustrated in FIG. 26;

FIG. 28 is a cross-sectional view through the load carrying assembly illustrated in FIG. 26;

FIG. 29 is a partial longitudinal sectional view through the load carrying assembly illustrated in FIG. 26

FIG. 30 is an exploded perspective view of the clamp bar shown in FIG. 16;

FIG. 31 is a cross-sectional view in partial perspective through the clamp bar shown in FIG. 30;

FIG. 32 is a cross-sectional view of the clamp bar and the attached portion of the vehicle tub.

### DETAILED DESCRIPTION OF THE EMBODIMENTS

### Load Carrying Assemblies—First Embodiment

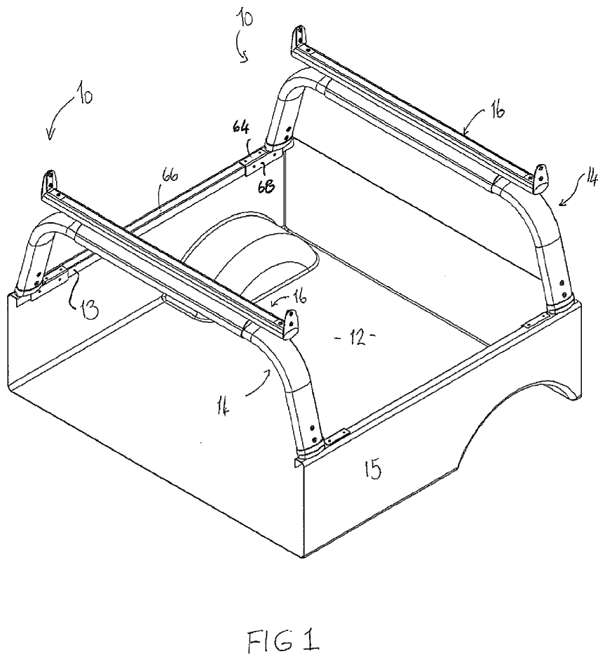

FIG. 1 illustrates two installed load carrying assemblies 10, according to a first embodiment, installed on the rear stowage compartment 12 of a utility vehicle. The cab of the vehicle is not shown. To understand the orientation, it will be appreciated that the compartment 12 is open at the rear of the vehicle. Typically, the compartment 12 would have a pivoting tailgate (not shown) in the opening so that the stowage compartment 12 is in the shape of a tub having side walls including inner wall surfaces 13 and outer wall surfaces 15.

As shown, there are two load carrying assemblies 10 spaced longitudinally of the vehicle, with each load carrying assembly 10 extending across the stowage compartment 12. Thus, the two load carrying assemblies provide support for a load (not shown) spanning between the two load carrying assemblies 10, e.g. skis, surfboards, canoe, rooftop tent.

Each load carrying assembly 10 includes an accessory bar 14 with an optional crossbar 16 mounted atop the accessory bar 14 in a manner which will be explained. As can be best seen from an inspection of FIG. 11, the usable i.e. transverse (straight) portion of the accessory bar 14, between the bend portions of the elbows 20 is shorter than the usable length of the crossbar 16. Therefore, the optional crossbar 16 provides a greater usable width for the stowage items. This may be especially desirable in the case of a rooftop tent or a boat.

### Accessory Bar

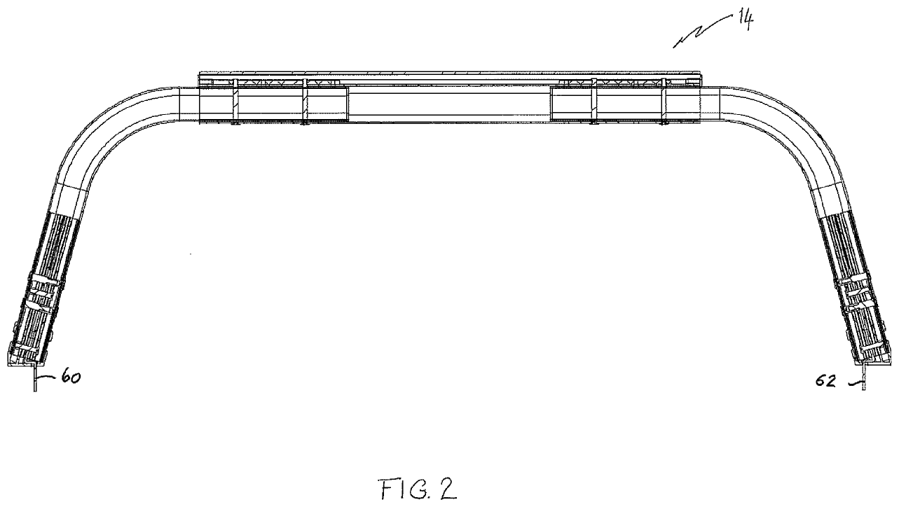

FIG. 2 is a longitudinal sectional view through the accessory bar 14 including mounting brackets 60, 62, and FIG. 3 illustrates all of the parts making up the accessory bar 14.

As best shown in FIG. 3, the accessory bar 14 includes a spanning member 18 and two elbows 20. Each elbow 20 is received within the spanning member 18 for telescopic sliding movement therewith. To facilitate the telescopic sliding movement, each elbow has a heat shrinkable plastic sleeve 22. Each elbow comprises an inclined supporting portion 24, a bent portion 25 and a crosswise portion 26. Each plastic sleeve is shrunk to fit tightly around the inward end of the crosswise portion 26. The function of the plastic sleeves is to prevent oxidation build up between the two metal surfaces of the telescopic members thus preventing a corrosive effect and the two parts becoming non-adjustable. Each elbow 20 is formed from extruded hollow tubular section which is bent to the desired shape. The cross-sectional shape of each elbow may be elliptical or oval. The elbows 20 are the same.

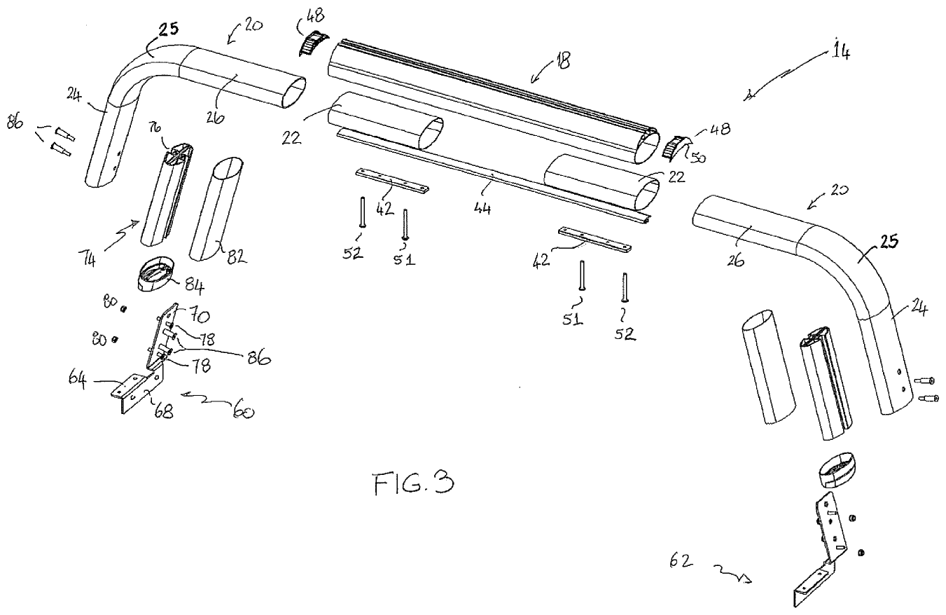

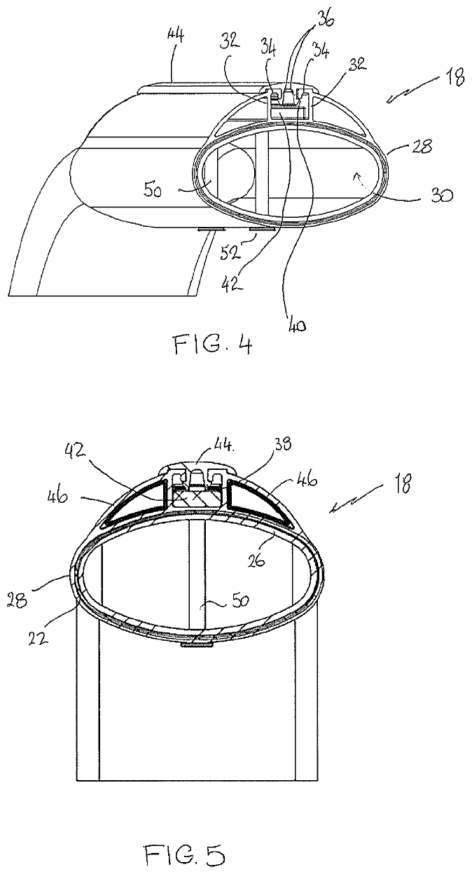

Referring to FIGS. 4 and 5, the cross-sectional shape of the spanning member 18 can be more clearly seen. The spanning member 18 is formed from an extruded hollow tubular section which has various different wall portions which can be seen from FIGS. 4 and 5. The cross-sectional shape is uniform along the length of the spanning member 18. The cross-sectional shape includes a lower oval portion 28. The lower oval portion 28 of the cross-sectional shape extends uniformly to define an oval bore 30 of uniform dimensions to receive the crosswise portion 26 of the associated elbow 20.

Above the lower oval portion 28 of the cross-sectional shape are two spaced upstands 32 which have inwardly facing ledges 34 and downwardly oriented returns 36. The two spaced upstands 32 face each other to define a longitudinal channel 40 above the bore 30. Two lock members 42 are received within the longitudinal channel 40 (as shown in FIG. 3). The purpose of the lock members 42 will be explained subsequently. The longitudinal channel 40 has an upper slit between the two downwardly oriented returns 36. The slit receives a weather strip 44 to close the channel 40. In cross-section, the weather strip 44 has two longitudinally extending prongs with barbed ends 38. The barbed ends 38 hook underneath the downwardly oriented returns 36 to secure the weather strip 44 in position, along the length of the weather strip 44. The cross-sectional shape of the weather strip 44 is uniform along its length.

To provide structural strength for the upstands 32, two bridging portions 46 extend, in each case, from the upper side of the lower oval portion to the top or adjacent the top of the upstands 32. Overall, the lower oval portion 28, the upstands 32, the facing ledges 34, the downwardly oriented returns 36 and the bridging portions 46 are all part of a unitarily extruded hollow section. The cavities defined beneath the bridging portions 46 and the channel 40 are closed at each end of the spanning member 18 by end caps 48 (see FIG. 3). The end caps 48 are a plastic moulded part defined by an end plate 50 and three projections from the end plate 50, each of which project into a respective cavity/channel.

### Spacing Adjustment

As mentioned, the elbows 20 are telescopically slidable with the spanning member 18 to adjust the spacing between the elbows 20. This allows the accessory bar 14 to be adapted to the user's specific vehicle dimensions. With known utility vehicles on the market in Australia, there is a variation of about 50 mm in the dimension across the stowage compartment of the vehicle between the inner wall surfaces 13. The telescopic adjustment of the accessory bar 14 allows for this variation and therefore allows the accessory bar 14 to be installed on a wide range of utility vehicles.

The lock members 42 are used to secure the relative position between the spanning member 18 and respective elbows 20. One lock member 42 is dedicated to secure one of the elbows 20 with the corresponding end of the spanning member 18. Likewise, a second lock member 42 is used to secure the other elbow 20 with the corresponding end of the spanning member 18. As already mentioned, the lock members 42 are received in the longitudinal channel 40. The lock members 42 can be slid along the channel 40 for ease of assembly as will be explained. However, the home position of each lock member 42 is near the associated end of the spanning member 18.

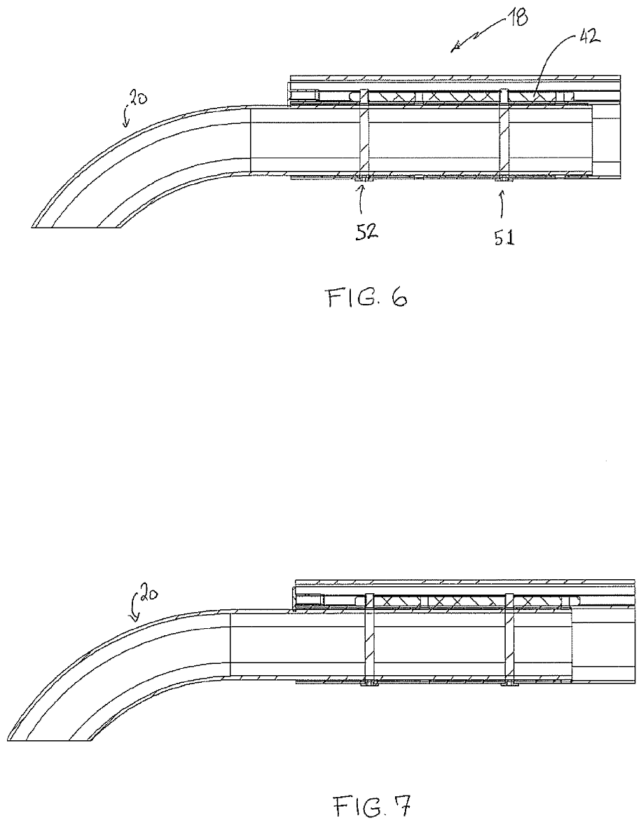

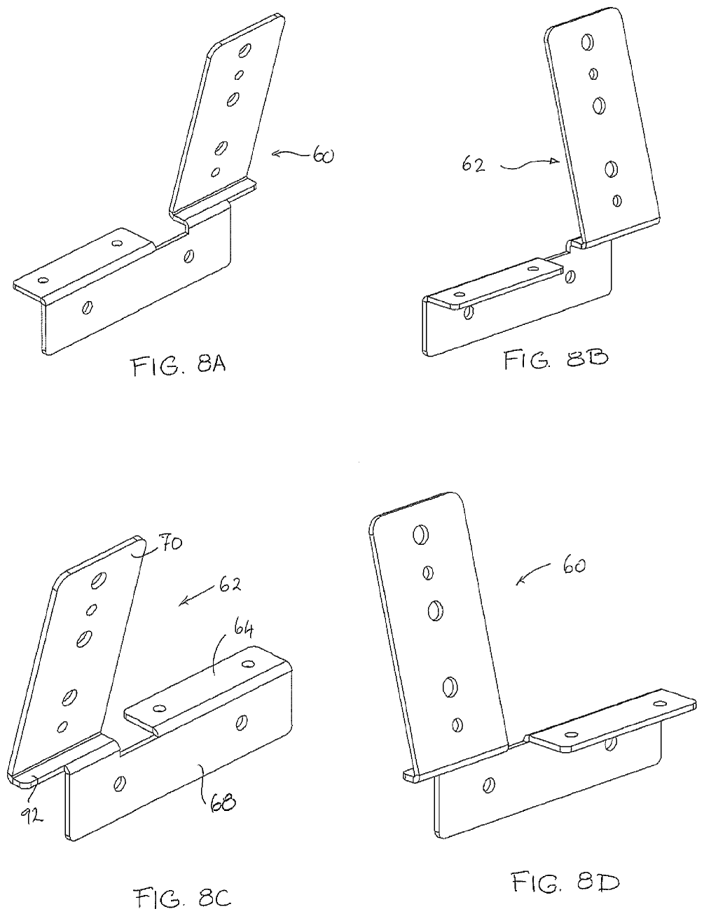

As best seen from FIGS. 6 and 7, each end of the spanning member 18 has two spaced pairs of holes which are spaced longitudinally along the spanning member 18. Each pair includes aligned holes, extending from the lower to the upper part of the oval portion 28. As best shown in FIG. 5, this enables a fastener 52 to project from beneath the oval portion 28 with the threaded end of the fastener 52 projecting into the longitudinal channel 40. As will be understood from FIG. 5, the threaded end of the fastener 52 engages with threaded holes in the lock member 42.

Each elbow 20 (and associated sleeve 22) is provided with a longitudinally spaced series of pairs of holes, with each pair arranged on the underside and the upper side of the crosswise portion of the elbow 20. To secure the elbow 20 at the desired relative position with the spanning member 18, a pair of holes in the elbow 20 are aligned with a pair of holes in the spanning member 18 to form an aligned set as best shown in FIG. 6. To aid with this alignment, the user initially moves the associated lock member 42 in the direction away from the associated end of the spanning member 18. This allows the user to inspect the alignment of the two pairs of holes by looking through the channel 40. A screwdriver or a special-purpose tool may be inserted to assist alignment of the two pairs of holes. As will be understood from an appreciation of FIG. 6, longitudinally spaced along the spanning member 18 is another set of two pairs of aligned holes. Once the first set is aligned then the second set of holes will also align. Markings and/or other indicia may be provided on all or any of: the elbow 20, the spanning member 18; and the lock member 42. Such markings or other indicia may allow the user to effect the appropriate alignment.

When the user is satisfied that the two sets of holes are aligned, he/she may return the lock member 42 back to the associated end of the spanning member 18 by sliding along the channel 40 until threaded holes in the lock member 42 align with first and second sets of holes. Once alignment is achieved, a first fastener 52 is inserted through the first set of aligned holes into the corresponding aligned threaded hole in the lock member 42 and a second fastener 52 is inserted through the second set of aligned holes into the corresponding aligned threaded hole in the lock member 42. The relative position of the elbow 20 and the spanning member 18 is thereby secured. In a similar manner, relative adjustment is permissible between the other elbow and the spanning member 18 to achieve the desired overall width of the accessory bar 14.

Since the position of each elbow 20 relative to the spanning member 18 will vary according to the desired spacing between the elbows 20, the crosswise portion 22 of each elbow may be provided with a series of alternative pairs of holes for passage of the fasteners 51, 52. In one embodiment, each alternative hole pair in the series may correspond to the desired spacing for a particular vehicle. In another embodiment, the series of alternative hole pairs may provide for incremental spacing adjustment of a predetermined increment. In yet another embodiment, the user may drill aligned hole pairs through the crosswise portion 22 to suit the desired spacing.

### Height Adjustment

The accessory bar 14 is also provided with a height adjustment mechanism at the lower end of each inclined supporting portion 24. The accessory bar 14 enables the user to adjust the overall height of the spanning member 18 and likewise, when a crossbar 16 is attached, to also adjust the overall height of the crossbar 16. Referring to FIG. 1, the user may be able to position certain items between the two load carrying assemblies 10, irrespective of the height of the cab. However, for longer items, if the height of the cab is higher than the height of the spanning member 18, or the crossbar 16 (where the optional crossbar 16 is utilised) then this will limit the overall length of stowage items. For this reason, the accessory bar 14 is height adjustable to raise the height above the cab, as will be explained.

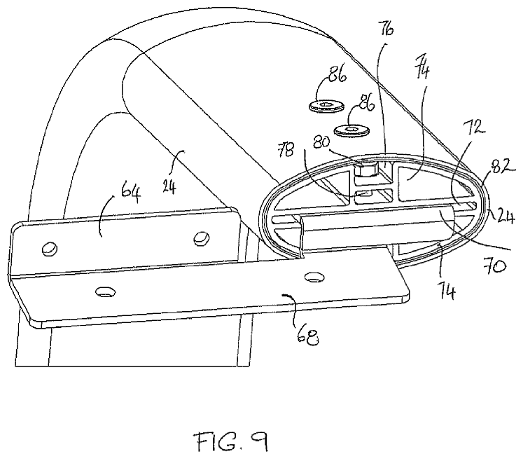

The height adjustment mechanism includes stationary vehicle mounts in the form of brackets 60, 62 as shown in FIG. 3. Each vehicle mount 60, 62 is attached to the stowage compartment 12 as shown in FIG. 1. As shown in FIGS. 1 and 8, each vehicle mount 60, 62 includes a first portion 64 to bear against an upper surface 66 of the stowage compartment 12, a second portion 68 to bear against the inner wall surface 13 of the stowage compartment 12 a third portion third portion for connection to the accessory bar (see FIG. 3).

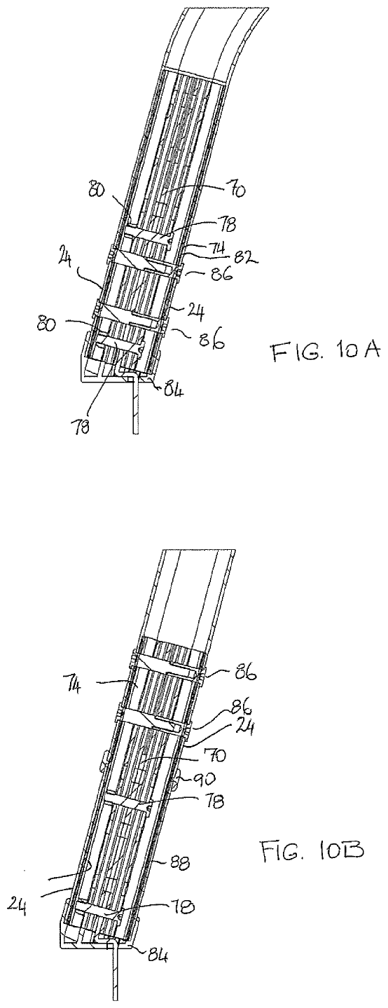

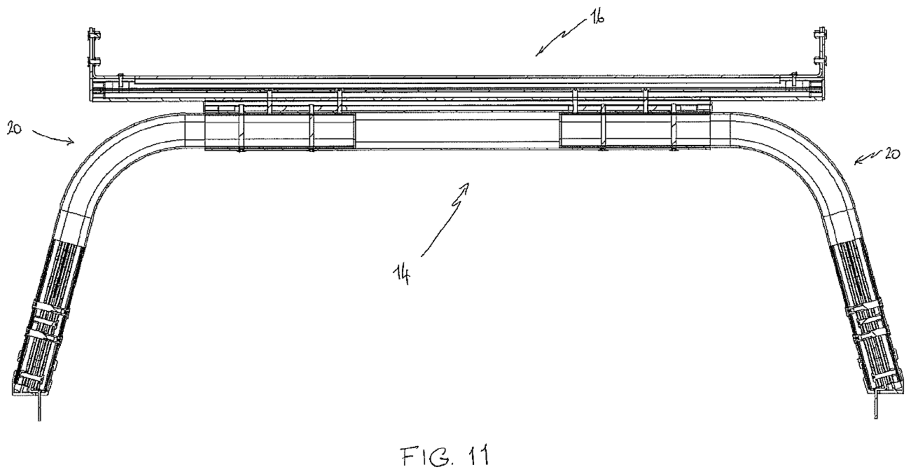

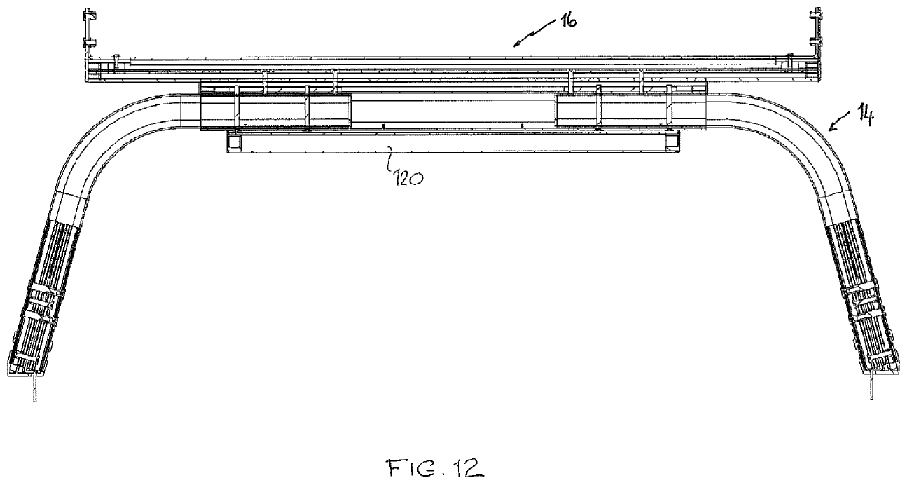

The third portion 70 is in the form of an angled sheet metal plate which is inclined to the vertical in its installed position on the vehicle. As best shown in FIG. 9, the third portion 70 is received in a slot 72 provided in an inner bar 74, forming part of the vehicle mount. The inner bar 74 is an extruded hollow section. The inner bar 74 defines the slot 72 which extends across the longest dimension of the cross-section. The inner bar 74 also defines two longitudinal recesses 76 on each side of the slot 72. The inner bar 74 and the third portion 70 are fastened together by means of fasteners 78 which thread with nuts 80 as can be best seen in FIG. 10. The head of each fastener 78 is received in one of the recesses 76, while the respective nut 80 is received in the other recess 76. The vehicle mounts 60, 62 are fixed relative to the vehicle stowage compartment 12. Likewise, the inner bar 74 is fixed relative to the associated vehicle mount 60, 62. Therefore, the fasteners 78 remain in the same position, irrespective of the height adjustment. This can be seen from a comparison of FIG. 10A and FIG. 10B.

A heat shrinkable plastic sleeve 82 (see FIG. 3) is fitted over the inner bar 74. The inner bar 74 and the heat shrinkable plastic sleeve 82 are received within the lower end of the elbow 20, specifically the inclined supporting portion 24.

The height adjustment is realised by sliding telescopic adjustment between the inner bar 74 (and the heat shrinkable plastic sleeve 82) on the one hand and the inclined supporting portion 24, on the other hand.

In FIG. 10A, the inclined supporting portion 24 completely receives the inner bar 74. In other words, the lower ends of the inclined supporting portion 24 and the inner bar 74 are coterminous. The coterminous lower ends are received within a plastic boot 84 which protects the upper edge 66 of the stowage compartment from scratching by the lower ends. The relative position of the supporting portion 24 and the inner bar 74 are secured by means of suitable fasteners 86 which extends through the supporting portion 24 and the inner bar 74 as well as the mounting plate 70. FIG. 10A depicts the lowest selectable position of the accessory bar 14.

FIG. 10 B depicts the highest position of the accessory bar 14. In the highest position, the inclined supporting portions 24 are elevated by 150 mm along the length of the inner bar 74 and secured in position by fasteners 86. Markings and/or other indicium may be provided to ensure correct relative positioning for alignment of holes. In this case, the fasteners 86 extend through holes in the inclined supporting portion 24 and the inner bar 74 but not the third mounting portion 70. In this position, the lower end of the inclined supporting portion 24 is no longer coterminous with the inner bar 74. The lower end of the inner bar 74 is therefore covered by a cover 88. The cover 88 is the same cross-sectional dimension as the supporting portion 24, leading to a seamless appearance with the supporting portion 24. To improve the appearance, a join cover 90 is provided.

There are two intermediate positions between FIG. 10A and FIG. 10B which are not shown. The two intermediate positions are at 50 mm and 100 mm. At each of the intermediate positions, an appropriate cover 88 may be provided. Thus, there are four selectable height positions for the accessory bar 14 at 50 mm height increments i.e. zero, 50 mm, 100 mm and 150 mm extension. The accessory bar may come in kit form together with covers 88 of appropriate length to suit any of these height increments. Alternatively, the longest required length cover 88 may be provided, enabling the user to cut the cover 88 to the required length.

### Assembly

When the owner is ready to install the accessory bar 14, the owner assembles the accessory bar on a workbench. Initially, each mounting bracket 60, 62 is assembled with its corresponding inner bar 74 and elbow 20 and adjusted to the selected height. As shown in FIG. 8, there are two differently shaped mounting brackets 60, 62. The two different shapes are used in a single accessory bar 14, at opposite ends. The orientation of the mounting brackets 60, 62 depends upon whether the accessory bar is the front accessory bar or the rear accessory bar (as per FIG. 1) and the appropriate orientation is illustrated in FIG. 8.

The user then measures the distance between the inner wall surfaces 13 of the stowage compartment 12 to obtain the required spacing between the two second portions 68 of the mounting brackets 60, 62. Alternatively, the user may be informed of the required spacing for a particular vehicle.

The user then assembles the accessory bar 14 on a workbench with the mounting brackets 60, 62 placed at the required spacing. This enables the user to adjust the relative positioning of the elbows 20 and the spanning member 18 to achieve the required spacing between the second portions 68 of the mounting brackets. The user aligns the holes as explained above and then inserts the fasteners into the lock member 42 to secure the elbows 20 and the spanning member 18 at the selected spacing. However, in the event that the holes in the crosswise portion 22 do not align with the holes in the spanning member 18, the user can drill appropriate holes in the crosswise portion 22.

Once the accessory bar 14 has been fully assembled, the user places the accessory bar on the vehicle at the appropriate location to check the spacing between the mounting bracket 60, 62. Assuming the accessory bar 14 has been assembled to the appropriate spacing, the user marks the position of required holes in the upper edge 66 and the inner wall surface 13 by using the mounting bracket 60, 62 as a template. As can be seen in FIG. 3, the mounting bracket contains various holes—a pair of holes in the first portion 64 and a pair of holes in the second portion 68.

Once the user has drilled the required holes in the vehicle, the user fastens the accessory bar 14 to the vehicle.

### Mounting Bracket

The design of the mounting bracket 60/62 can be best appreciated from a study of FIG. 8C. The first portion 64 bears against the upper edge 66 of the stowage compartment. The first portion 64 therefore transfers a large proportion of the weight of the loaded accessory bar 14 to the vehicle. The first portion 64 has a pair of spaced holes to secure the first portion.

The second portion 68 assists with alignment of the mounting bracket 62 by resting against the inner wall surface 13 of the stowage compartment. The second portion 68 is also provided with a pair of spaced holes. These holes in the second portion 68 assist to secure the mounting bracket 62 against sideways loads longitudinally of the vehicle. For example, if the vehicle comes to a sudden stop then the bending moment will tend to rotate the third portion 70 in a direction which will tend to strip the threads of the fasteners through the holes in the first portion 64. Therefore, under such a bending moment, the fasteners in the second portion 68 will be loaded across the thickness of the fasteners providing a greater resistance to the bending moment. This provides additional rigidity to the mounting bracket.

Additionally, the design of the mounting bracket 62/60 has the third portion 70 projecting upwardly from the remainder of the mounting bracket by means of an offset portion 92. Like the first portion 64, the offset portion 92 also bears against the upper edge 66 of the stowage compartment 12 to support the weight of the loaded accessory bar 14. The other advantage of the offset third portion 70 is that it places the third portion 70 further to the outside of the storage compartment to avoid intrusion into the stowage area. This avoids the third portions and the lower end of the accessory bar 14 from fouling with the load.

The arrangement of the first, second and third portions provides a structurally rigid form which acts as an angular brace or gusset. In particular, the first, second and third portions have a lengthwise direction, with the lengthwise direction of the third portion arranged to extend transversely to the first and second portions. The first and second portions may lie in planes which are orthogonal to each other. The third portion may lie in a plane which is angled to the planes of the first and second portions. Preferably, the third portion lies in a plane which extends at an acute angle to the first portion and at an oblique angle to the second portion.

### Crossbar

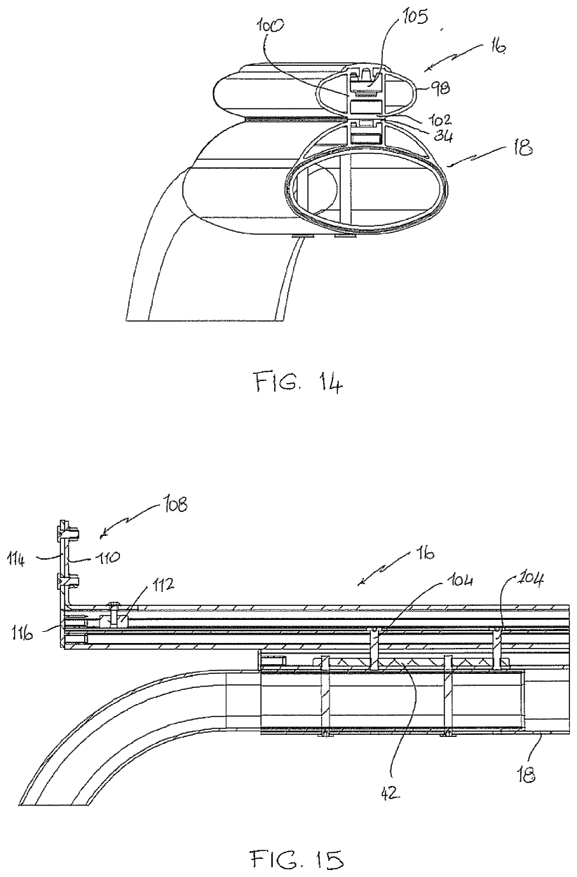

FIGS. 13 through 15 illustrate the crossbar 16. In FIG. 13, the crossbar comprises an elongate member 96. The form of the elongate member 96 is an extruded metal hollow section as will be appreciated from FIG. 14. The elongate member 96 has a uniform cross-section extending along its length, including an external oval section 98 with an internal H section 100. The underside 102 of the external cross-section is flat and bears against the upper surface of the ledges 34 of the spanning member 18. The ledges 34 of the spanning member 18 thereby support the weight of the loaded crossbar 16. (When the crossbar 16 is assembled with the accessory bar 14, the weather strip 44 is removed.)

The elongate member 96 is secured to the spanning member 18 by means of fasteners 104. The head of the fasteners sit within the upper cavity 105 of the internal H section 100 and project through the web of the H section 100. The fasteners 104 thread into the same locking member 42. The position of the elongate member 96 relative to the spanning member 18 is fixed. The position of the locking member 42 is also fixed relative to the spanning member 18 once the accessory bar 14 has been assembled. Therefore, the locking member 42 provides dedicated threaded holes to receive the fasteners 104.

Once the elongate member 96 is assembled with the accessory bar 14, the weather strip 106 is inserted to close the upper cavity 105.

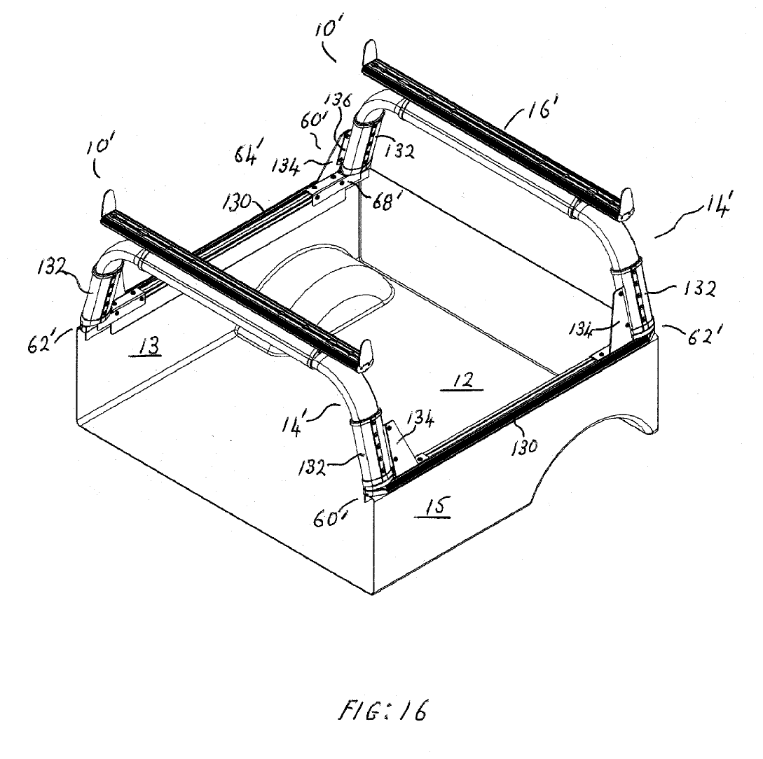

The cross bar 16 also includes bookends 108 at opposite ends. The bookends 108 include an L-shaped bracket 110 which is placed on top of the elongate member 96. A lock nut 112 is received in the upper cavity 105. The L-shaped bracket 110 is thereby secured to the elongate member 96 as shown in FIG. 15. An upright plate 114 is then fastened to the L-shaped bracket 110. The open end of the elongate member 110 is closed by an endcap 116.

### Light Bar

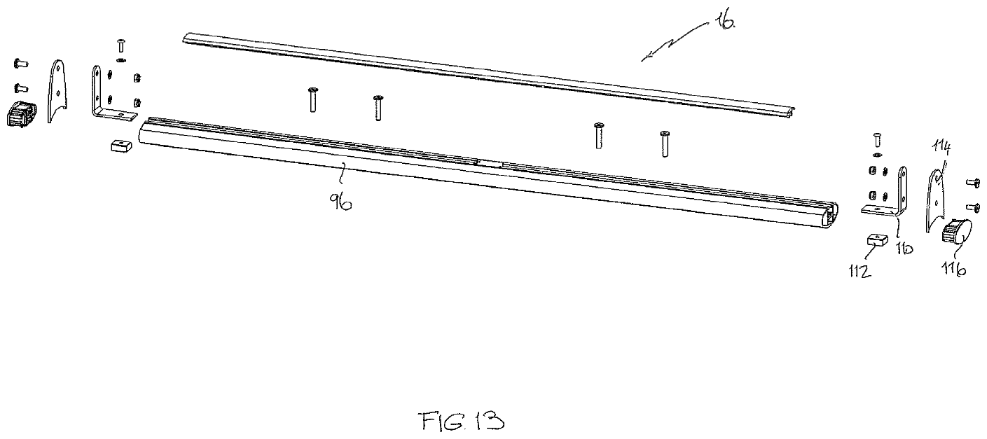

FIG. 12 illustrates the crossbar 16 assembled with the accessory bar 14. FIG. 12 illustrates the crossbar 16, accessory bar 14 and a light bar 120 assembled together.

The light bar 120 is attached to the accessory bar 14.

### Load Carrying Assemblies—Second Embodiment

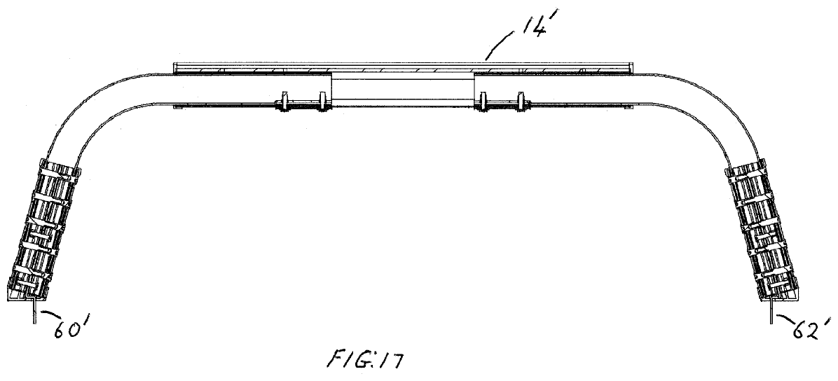

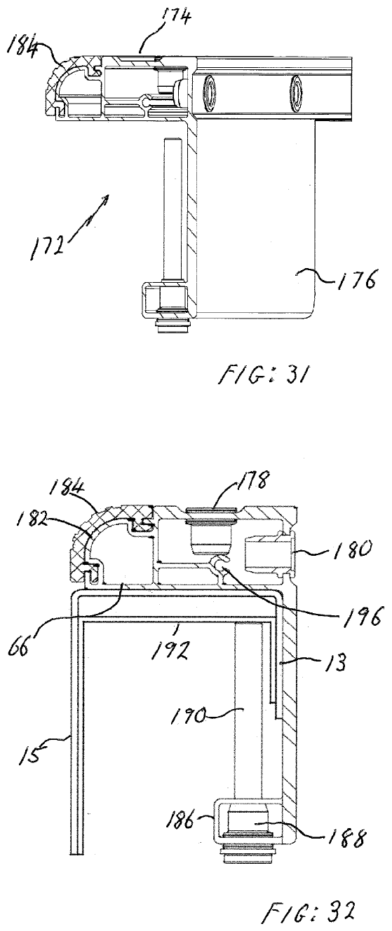

FIGS. 16-32 illustrate a second embodiment of a load carrying assembly 10′. The second embodiment is similar in many respects to the first embodiment of the load carrying assembly 10, except in the respects that will be discussed below. Accordingly, like reference numerals will be used to represent like parts and the explanation above in connection with the first embodiment applies to the second embodiment, except as otherwise noted below. To indicate the adaptation of a particular part to the new embodiment, the prime symbol (′) will be used to indicate that the part has been adapted.

FIG. 16 illustrates to installed load carrying assemblies 10′ installed on the rear stowage compartment 12 of a utility vehicle. The configuration is substantially the same as shown in FIG. 1. However, it will be noted that the vehicle mounts 60′, 62′ no longer fasten directly to the stowage compartment 12 of the vehicle. Rather, a clamp bar 130 is provided. The vehicle mounts 60′, 62′ are fastened to the clamp bar 130 and the clamp bar 130 is clamped to the stowage compartment 12, rather than being secured with fasteners. This obviates the need to drill holes into the stowage compartment 12 which simplifies installation and avoids devaluation and marring of the vehicle by drilling holes in the stowage compartment 12.

### Modified Vehicle Mounts

The other evident change in FIG. 16 is the strengthening of the vehicle mounts 60′, 62′. The vehicle mounts 60′, 62′ are strengthened in two ways. Firstly, each vehicle mount 60′/62′ has an outer shroud 132 which surrounds the supporting portion 24 of the associated elbow 20′. Secondly, each vehicle mount 60′ is provided with a gusset 134. The gusset 134 attaches to a rib 136 which extends from the outer shroud 132.

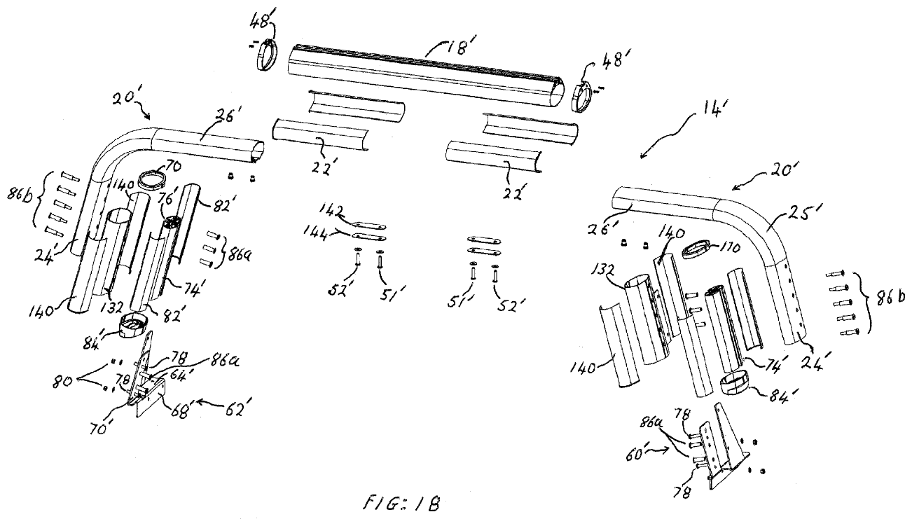

Reference is now made to FIG. 18 which in many respects is similar to FIG. 3.

### Liner Shells

The spanning member 18′ receives plastic liner shells 22′ so rather than the annular plastic sleeve 22, the liner shells 22′ are arranged in pairs of liner shells, each liner shall having a C cross section and each pair being assembled inside the oval bore 30′ of the spanning member 18′ to form a split annulus (see FIG. 19 for further detail). Inside the spanning member 18′, there are the pairs of liner shells 22′ are arranged at each end of the spanning member 18′. The function of the plastic liners/sheathes is to prevent oxidation build up between the two surfaces of the metallic telescopic parts thus preventing a corrosive effect and the two parts becoming non-adjustable.

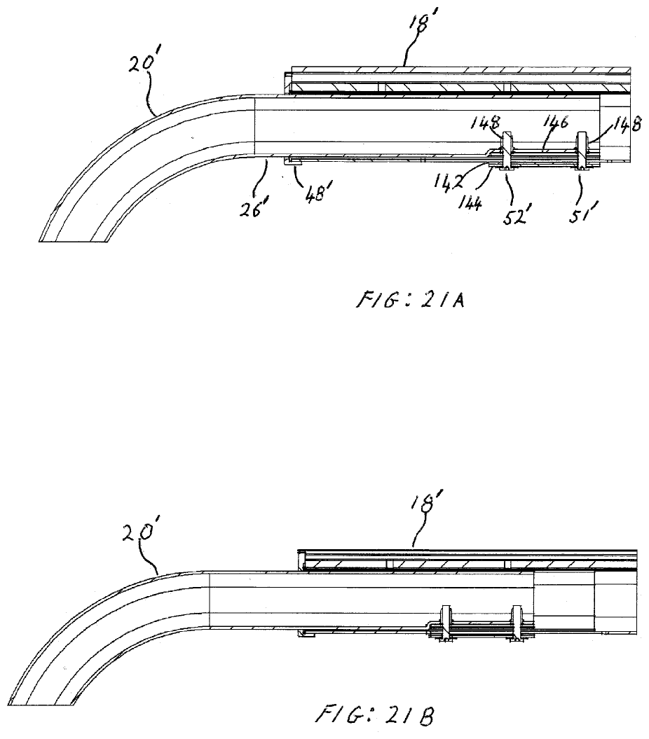

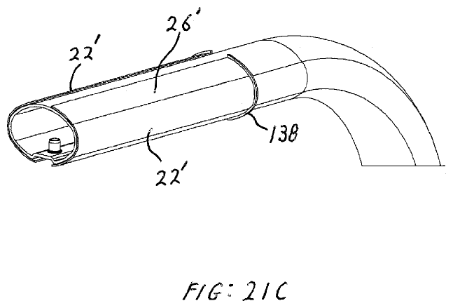

The liner shells 22′ facilitate the telescopic sliding movement of the crosswise portion 26′ inside the spanning member 18′. FIG. 21C illustrates a pair of liner shells 22′ assembled on the inner end of one of the crosswise portions 26′. As can be seen, each liner shell 22′ includes an upturned lip 138. Each end of the spanning member 18′ is closed by way of end caps 48′ (see FIG. 48′). The end caps 48′ each have an opening to receive the associated crosswise portion 26′. The upturned lips 138 however are sized so that each is held captive by the adjacent end cap 48′, to prevent the liner shells 22′ from sliding out of the spanning member 18′ as the crosswise portion 26′ is withdrawn when adjustment is effected.

Reverting to FIG. 18, it can be seen that each plastic sleeve 82 from the first embodiment is replaced with a pair of liner shells 82′ which form a split annulus around the inner bar 74′.

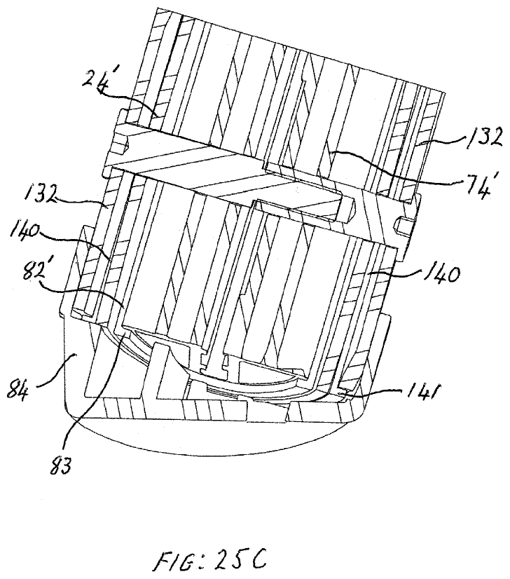

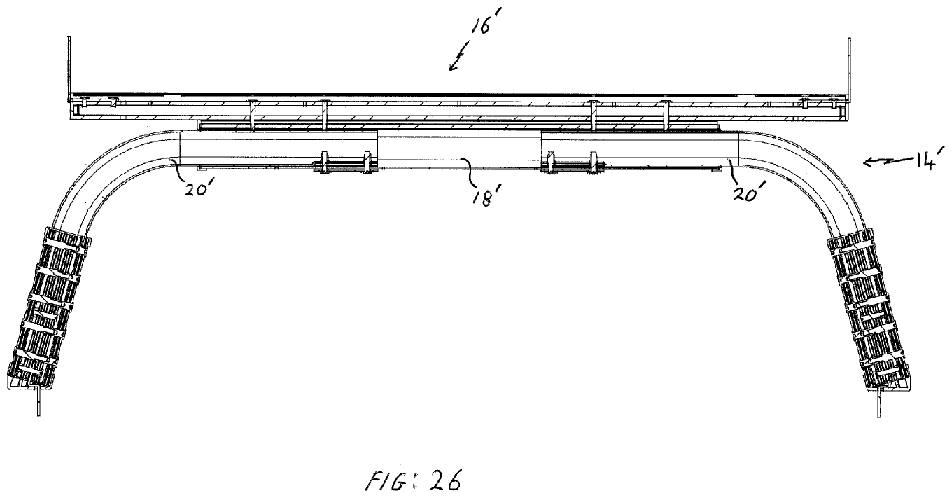

Additionally, it will be understood that each outer shroud 132 surrounds the supporting portion 24′ of the associated elbow 20′. A pair of liner shells 140 also lie between the supporting portion 24′ and the outer shroud 132. Reference is now made to FIG. 25C which shows the lower end of the assembled supporting portion 24′ within the outer shroud 132 with the inner bar 76′ inserted inside the supporting portion 24′. FIG. 25C also shows the intervening liner shells 82′ and 140. In particular, it can be seen that the liner shell 140 has an out turned lip 141 which is retained underneath the outer shroud 132, to retain the liner shell 140 in position while the supporting portion 24′ is permitted to slide for height adjustment of the accessory bar 14′. Additionally, the liner shell 82′ has an in-turned lip 83 to retain the liner shell 82′ in position while the supporting portion 24′ slides relative thereto.

### Modified Spacing Adjustment

FIG. 18 also illustrates new components which facilitate the sliding adjustment of the spanning member 18′ and the elbows 20′. These components include gasket and metal plate 144. These components cooperate with fasteners 51′ and 52′ and associated washers as will be explained.

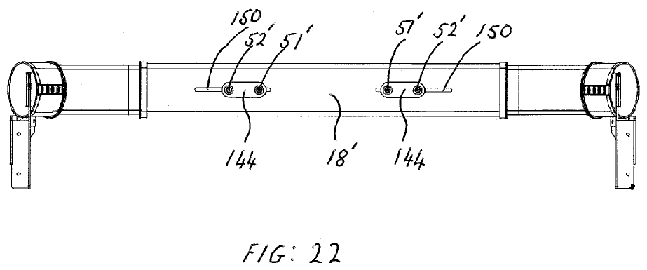

Reference is now made to FIGS. 19-22 in order to appreciate the modified adjustment mechanism to adjust the spacing of the elbows 20′ relative to the spanning member 18′. As will be understood from FIG. 19 and FIG. 21A, the crosswise portion 26′ of the elbow 20′ is provided with a longitudinally extending recess 146 extending from near the end of the crosswise portion 26′ to the inner end of the crosswise portion 26′. Within this recess are secured two longitudinally spaced threaded inserts 148, for example sold under the brand NUTSERT. The threaded fasteners 51′ and 52′ are threadingly engageable with the threaded inserts 148 which, along with the clamping plate 144 and gasket 142, clamp the crosswise portion 26′ relative to the spanning member 18′. From FIG. 22, it can be seen that the spanning member 18′ includes two longitudinally spaced slots 150. Thus, the clamped position of each crosswise portion 26′ can be adjusted relative to the spanning member 18′. In this manner, the relative spacing of the elbows 20′ can be adjusted in order to adapt the accessory bar 14′ to the particular vehicle. This is a superior arrangement to the first embodiment because the slot allows an infinite variety of adjustment positions within a specified range of the slot, allowing the accessory bar 14′ to be adjusted to snuggly fit the stowage compartment 12 of the vehicle, without the need for the user to drill any custom holes.

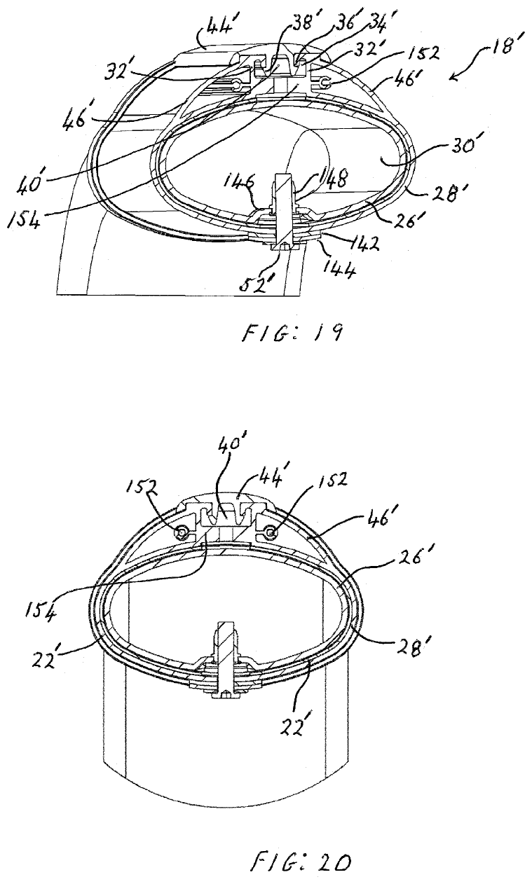

Reference is now made to FIGS. 19 and 20 which show screw grooves 152 formed as part of the extruded spanning member 18′. The screw grooves 152 are used to secure each end cap 48′ to the spanning member 18′. Each end cap 48′ sits proud of the associated end of the spanning member 18′.

It will also be appreciated from a comparison of FIG. 19 and FIG. 4, that the upstands 32′ form part of an H section, which is an integral part of the extruded spanning member 18′. The H section has a web 154 which is approximately 6 mm in thickness. Above the web 154 is provided a longitudinal channel 40′, the purpose of which will be subsequently explained.

### Cross Bar

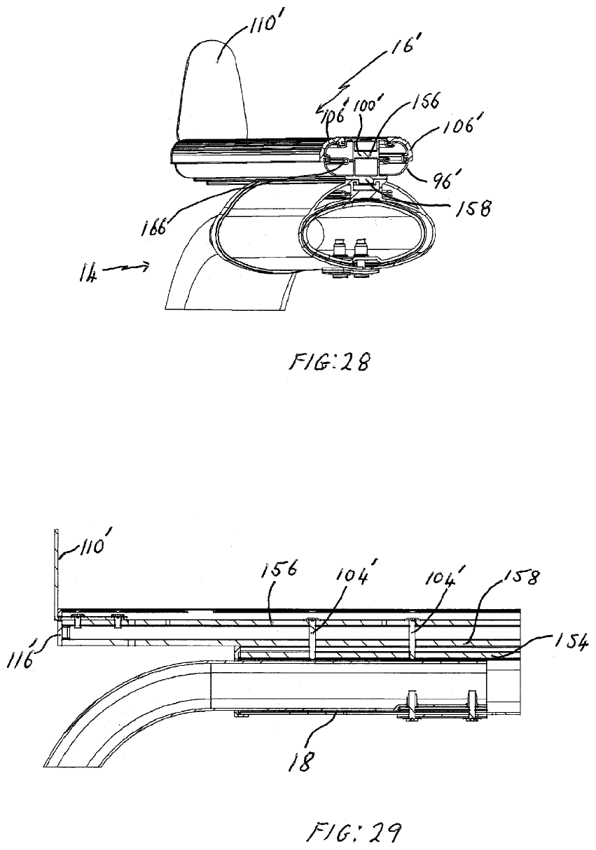

Reference is now made to FIG. 28 which shows the form of the crossbar 16′ mounted atop the accessory bar 14′. The crossbar 16′ is made up of an elongate member 96′ which is an extruded section. As part of the extruded section, the crossbar 96′ includes a lower rib 158 which extends substantially, if not the entire length of the elongate member 96′. The lower rib 158 is received within the longitudinally extending channel 40′ of the spanning member 18′ (refer to FIG. 19 for the longitudinally extending channel 40). Thus, the lower profile of the elongate member 96′ and the upper profile of the spanning member 18′ (with the weather strip 44′ removed) are complementary.

The internal H section 100′ has a web 156 of 4 mm in thickness. As can be seen from FIG. 29, the crossbar 16′ is secured to the spanning member 18′ by means of threaded fasteners 104′ which pass through the web 156, lower rib 158 and threadingly engaged with dedicated threaded apertures in the web 154 of the spanning member 18′.

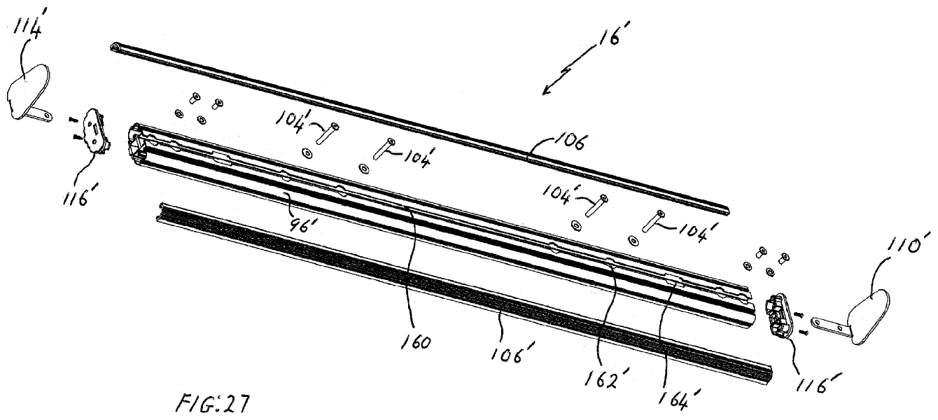

As can be seen from FIG. 27, the elongate member 96 includes an accessory groove 160 through which the threaded fasteners 104′ pass to be secured. Circular openings 162 are provided in the accessory groove 160 for passage of the threaded fasteners 104′. The accessory groove 160 includes square openings 164 to enable fitting of other accessories as is known in the art.

In the crossbar 16′, the weather strip included in the first embodiment is omitted. Instead, two plastic/rubber corner strips 106′ are provided to prevent scratching of items being loaded onto the crossbar 16′ and to protect the crossbar 16′.

The crossbar 16′ also includes bookends at opposite ends. Each bookend takes the form of an L-shaped bracket 110′. End caps 116′ close each end of the elongate member 96′. Each end cap 116′ includes a slot to receive the inner end of the associated L-shaped bracket 110′. The inner end of the L-shaped bracket 110′ is secured to the web 156 by suitable fasteners, which are depicted in FIG. 27. Screw grooves 166 (see FIG. 28) extend longitudinally of the extruded elongate member 96′ to secure the end caps 116′.

### Modified Vehicle Mounts

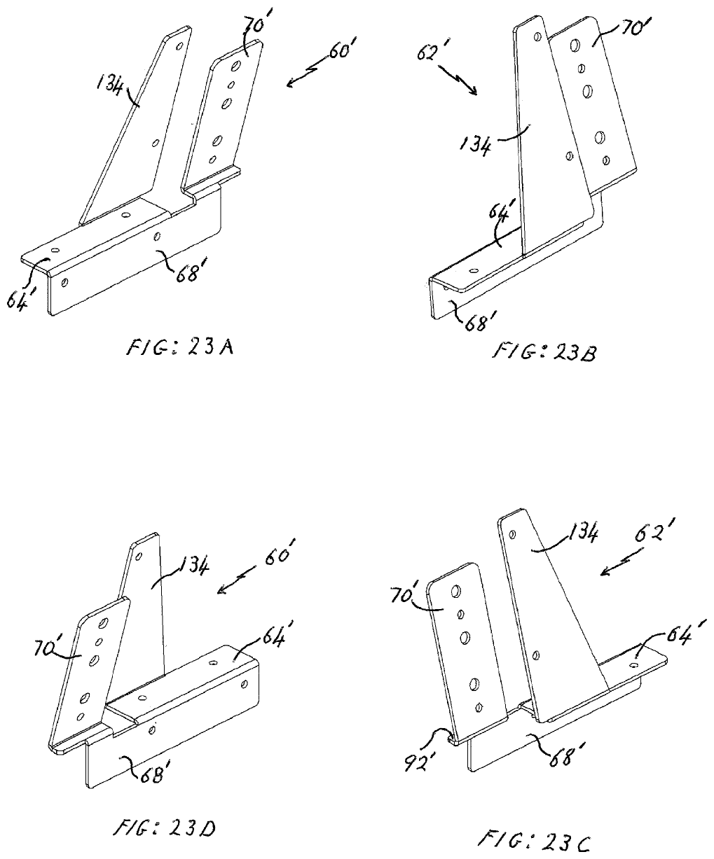

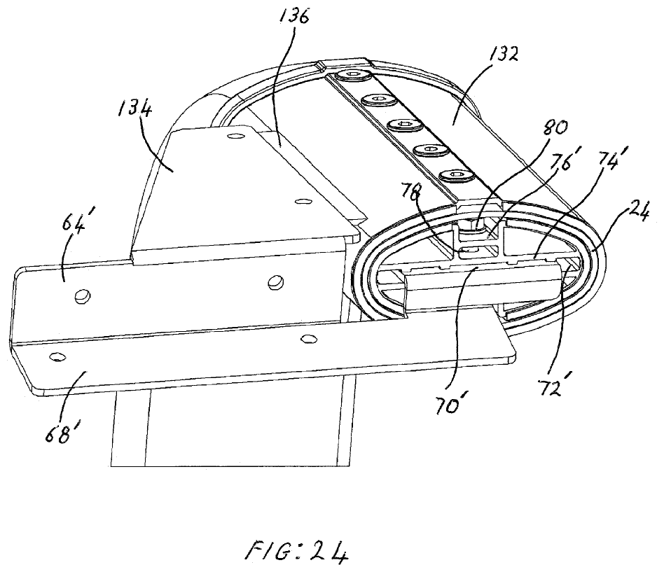

The modified vehicle mount will now be described in connection with FIGS. 23-25. Forming part of each vehicle mount is a bracket 60′, 62′. As will be understood from a comparison of FIG. 8, the brackets 60, 62 and 60′, 62′ are substantially similar in form and each similar part performs the same function. In addition, each bracket 60′, 62′ is provided with gusset 134 which extends upwardly from the first portion 64′ at an angle which is similar to the angle of the third portion 70′.

As described previously in connection with FIG. 9, the third portion 70′ is inserted into the inner bar 74′ and secured with fasteners 78 and bolts 80 (see also FIG. 25B).

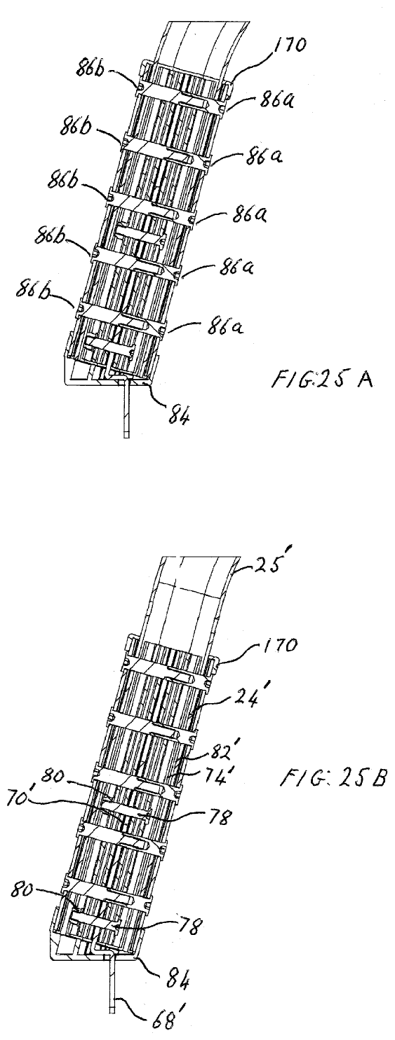

As will be understood from FIGS. 24 and 25, the vehicle mount is strengthened by the outer shroud 132. As best seen in FIG. 24, the outer shroud includes a rib 136 which is secured to the gusset 134. The outer shroud 132 is therefore fixed relative to the mounting bracket 60′, 62′ and therefore remains stationary while the supporting portion 24′ and the rest of the elbow 20′ is permitted to telescopically slide relative to the vehicle mount, including the mounting bracket 60′, 62′ and the outer shroud 132.

The supporting portion 24′ is fixed to the vehicle mount by means of male and female fasteners 86a, 86b as best shown in FIG. 25A and FIG. 25B. To permit relative movement of the supporting portion 24′ in order to effect height adjustment of the accessory bar 14′, the fasteners 86 are removed, the supporting portion 24′ is moved to the desired height and the fasteners 86 are reinserted. As can be seen from FIG. 18, the supporting portion 24′ of the elbow 20 has a series of spaced holes. Depending on the selected height of the accessory bar 14′, the fasteners 86 will pass through at least some of these holes.

As can be seen in FIG. 18 and FIGS. 25A and 25B, the join between the upper end of the outer shroud 132 and the supporting portion 24′ is covered by a closure ring 170 to minimise the ingress of dirt.

### Clamp Bar

As noted in reference to FIG. 16, the brackets 60′, 62′ are no longer secured directly to the vehicle. Rather, a clamp bar 130 is provided to obviate the need to drill holes in the vehicle. Two clamp bars 130 are provided on opposite sides of the vehicle, extending longitudinally at the top of the side walls of the vehicle. In the most preferred form, each clamp bar 130 supports two brackets 60′, 62′, each associated with a respective one of the two accessory bars 14′. However, individual clamp bars could also be provided and dedicated to each bracket 60′, 62′. Furthermore, the features of the bracket(s) could be incorporated into the clamp bar.

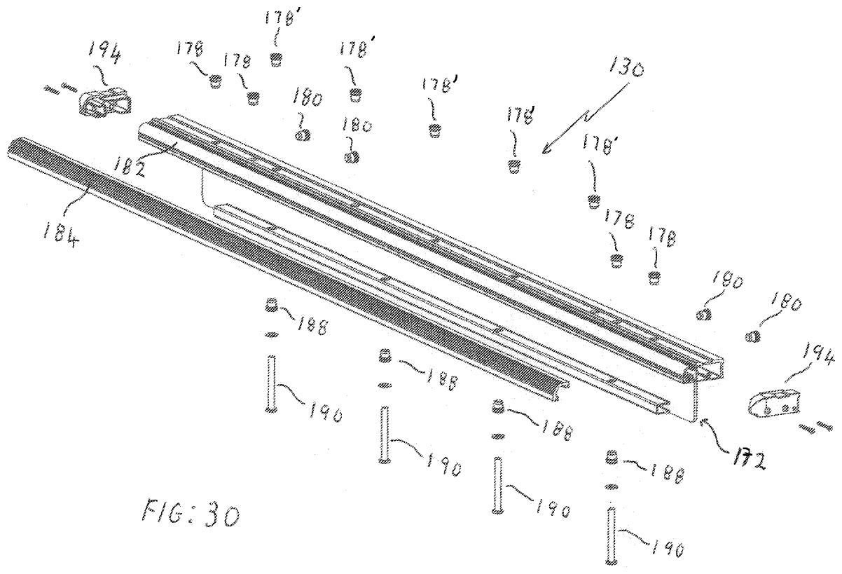

The clamp bar 130 is depicted in exploded form in FIG. 30. The clamp bar includes an elongate extruded section 172 having an approximately L-shaped cross section as shown in FIG. 32. The extruded section 172 includes a first elongate portion 174 which bears against the top surface 66 of the tub of the vehicle, and a second elongate portion 176 which bears against the side wall 13 of the vehicle. The top of the first elongate portion 174 includes apertures to receive threaded inserts 178 (nutserts).

The threaded inserts 178 receive fasteners to secure the first portion 64′ of the mounting bracket 60′/62′ thereto. The side of the first elongate portion 174 or the top of the second elongate portion 176 includes apertures to receive threaded inserts 180 (nutserts). The threaded inserts 180 receive fasteners to secure the second portion 68′ of the mounting bracket 60′/62′ thereto.

Additionally, nutserts 178′ are provided for tie down eyebolts where indicated.

The second elongate portion 176 includes a wall which is dependant from the first portion. The wall is shorter in overall length than the first portion 174. Thus, the wall has an end which is set back from the corresponding end of the first portion 174. This is more readily visible at the left end in FIG. 30.

As will be appreciated, in assembled configuration, the first portion 64′ of the mounting bracket 60′/62′ bears against the first elongate portion 174 of the clamp bar 130. The second portion 68′ of the mounting bracket 60′/62′ bears against the second elongate portion 176 of the clamp bar 130. The mounting bracket 60′/62′ is assembled with the clamp bar 130 in this configuration (see FIG. 16).

As shown in FIG. 32, the first elongate portion 174 is also provided with a rounded profile 182 along its external longitudinal edge. The rounded profile 182 is covered by an elongate rub strip 184 which is generally arcuate in cross sectional shape.

The lower end of the second portion is provided with a third elongate portion 186 which is in the form of an elongate box section which accommodates threaded inserts 188. Clamping bolts 190 pass through the threaded inserts 188. As can be seen from FIG. 32, the stowage compartment of the vehicle typically has a side wall which rises to an upper edge 66 which folds over to define an inside wall 13. As shown, this is a double skin construction with the outer skin defining the outer surface 15, the upper surface 66 and the inside surface 13. The inner skin defines an undersurface 192 underneath the upper surface 66. The upper end of the clamping bolts 190 bear against the undersurface 192.

Additionally, the ends of the elongate extruded section 172 are closed by end caps 194 by means of fasteners which secure into screw groove 196.

To assemble, clamp bars 130 are positioned on respective sides of the stowage compartment 12 and the clamp bars 130 are attached thereto by means of the clamping bolts 190. Four mounting brackets 60′/62′ are then attached to the two clamp bars 130 at suitable positions as shown in FIG. 16. The mounting brackets 60′/62′ are secured to the clamp bar through the use of fasteners which are received in the threaded inserts 178, 180.

The accessory bar 14′ is extended laterally to the desired spacing between the elbows in order to fit the vehicle concerned with the fasteners 51′ and 52′ being used to clamp the elbows 20′ relative to the spanning member 18′. Additionally, the accessory bar 14′ is set to the desired height by removing the fasteners 86 to allow the supporting portion 24′ to partially withdraw from the vehicle mount. The fasteners 86 are then replaced to fix the position of the supporting portion 24′.

The crossbar 16′ is attached to the accessory bar 14′ as described above.

1-7. (canceled)

8. A load carrying assembly for a range of variously sized utility vehicles, the assembly including:
an accessory bar including two supporting portions and a straight transverse portion extendable therebetween to define an inverted U shape in assembled configuration wherein the distance between the two supporting portions is adjustable to adapt the accessory bar for a range of various sized utility vehicles; and
a crossbar, wherein the crossbar is removably connectable to the accessory bar, the crossbar exceeding the transverse portion in length.

9. The load carrying assembly as claimed in claim 8 wherein the transverse portion and the crossbar are in direct contact with each other to support the crossbar along at least a central portion of its length.

10. The load carrying assembly as claimed in claim 8, wherein the supporting portions are inclined.

11. The load carrying assembly as claimed in claim 8, wherein the load carrying assembly is provided in kit form.

12. The load carrying assembly as claimed in claim 8, further including a first elongate clamp bar to clamp a portion of one or more the load carrying assembly to a first side the vehicle and a second elongate clamp bar to clamp another portion of the load carrying assembly to a second side of the vehicle, wherein a clamp mechanism is incorporated into each elongate clamp bar.

13. A vehicle mount to mount at least a portion of an accessory bar to a vehicle wherein the vehicle mount includes an elongate clamp bar which is removably attachable to the vehicle by clamping to the vehicle by means of a clamp mechanism, the elongate clamp bar forming part of the clamp mechanism and wherein the clamp bar has a profile shaped for engagement along its length with the side wall of the vehicle.

14. The vehicle mount as claimed in claim 13 wherein the elongate clamp bar is of a unitary one-piece extruded construction.

15. The vehicle mount as claimed in claim 13 wherein the elongate clamp bar includes:
a first portion having a substantially flat engagement surface for support by a top of the side wall of the utility vehicle; and
a second portion having a substantially flat engagement surface for support against an inner side of the side wall of the utility vehicle.

16. The vehicle mount as claimed in claim 15 wherein the elongate clamp bar is substantially L-shaped and the first portion and the second portion form respective legs of the L-shape.

17. The vehicle mount as claimed in claim 15 wherein the elongate clamp bar further includes an underhang lying below the first portion and the clamp mechanism includes a clamping member which is adjustably extendable from the underhang to bear against an underside of the top of the side wall of the vehicle.

18. The vehicle mount as claimed in claim 15, wherein the vehicle mount includes a mounting bracket to attach said at least a portion of the accessory bar to the clamp bar, wherein the mounting bracket is configured to transfer weight directly onto the first portion of the clamp bar such that the weight of the accessory bar is transferred to the clamp bar.

19. The vehicle mount as claimed in claim 18 wherein the mounting bracket includes:
a first portion for support by the first portion of the elongate clamp bar, the first portion having a lengthwise direction;
a second portion for support by the second portion of the elongate clamp bar, the second portion having a lengthwise direction; and
a third portion for connection to the accessory bar, the third portion having a lengthwise direction,
wherein the lengthwise direction of the third portion extends transversely to the lengthwise direction of each of the first and second portions.

20. The vehicle mount as claimed in claim 19 wherein the first, second and third portions are formed unitarily.

21. The vehicle mount as claimed in claim 19 wherein the first and second portions are connectable respectively to the first and second portion of the elongate clamp bar by way of mountings incorporated into the elongate clamp bar.

22. An accessory bar assembly for a utility vehicle, the assembly including:
an accessory bar including two supporting portions and a straight transverse portion extendable therebetween to define an inverted U shape in assembled configuration; and
two vehicle mounts as claimed in claim 13 to clamp the accessory bar to respective sides of the vehicle.

23. An accessory bar assembly including:
an accessory bar including two spaced upright or inclined supporting portions configured for assembly with a straight transverse portion extendable at least between the two spaced supporting portions to define an inverted U shape in assembled configuration, wherein the accessory bar includes telescopically slidable portions for telescopic adjustment thereof to effect height adjustment of the transverse portion in situ, and wherein a first annular sheath of plastic material is provided to insert between the telescopically slidable portions; the accessory bar assembly further including two vehicle mounts as claimed in claim 18 to clamp the accessory bar to respective sides of the vehicle, wherein the mounting bracket is configured such that when the first portion of the mounting bracket is supported by the first portion of the elongate clamp bar, and the second portion of the mounting bracket is supported by the second portion of the elongate clamp bar, the third portion of the mounting bracket extends at an angle corresponding to an inclined angle of a respective one of the supporting portions.

24. The load carrying assembly as claimed in claim 8, further including two vehicle mounts as claimed in claim 18 to clamp the accessory bar to respective sides of the vehicle, wherein the mounting bracket is configured such that when the first portion of the mounting bracket is supported by the first portion of the elongate clamp bar, and the second portion of the mounting bracket is supported by the second portion of the elongate clamp bar, the third portion of the mounting bracket extends at an angle corresponding to an inclined angle of a respective one of the supporting portions.

25. The accessory bar assembly as claimed in claim 22 wherein the vehicle mounts each includes an outer shroud which surrounds the supporting portion in the assembled configuration.

26. The accessory bar assembly or the load carrying assembly as claimed in claim 25 wherein the outer shroud includes a rib and the mounting bracket includes a fourth portion in the form of a gusset which is attachable to the rib on the outer shroud.

27-34. (canceled)
